(19) United States
(12) Patent Application Publication
(10) Pub. No.: US 2009/0128528 A1
(43) Pub. Date: May 21, 2009

(54) DISPLAY DEVICE AND A TELEVISION RECEIVER HAVING THE DISPLAY DEVICE

(75) Inventor: Yoshiki Takata, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 11/994,000

(22) PCT Filed: Jun. 1, 2006
(86) PCT No.: PCT/JP2006/310998

§ 371 Date: Feb. 8, 2008

(30) Foreign Application Priority Data
Jun. 27, 2005 (JP) 2005-187066

(51) Int. Cl. G06F 3/038

(52) U.S. Cl. 345/206

(57) ABSTRACT

A display device has a reduced number of components, assembly processes, and number of electric wires which can be impediments to the assembly process. The display device includes a liquid crystal display panel, a common circuit board attached to a peripheral portion of the liquid crystal display panel, lamps as light sources, and a light source driving circuit board that drives the lamps. A direct electric connection is established between the common circuit board and the light source driving circuit board, and the light source driving circuit board receives electric power to drive the lamps and a synchronizing signal via the direct electric connection.

### BACKGROUND OF THE INVENTION

1. Field of the Invention

The present invention relates to a display device such as a liquid crystal display device and a television receiver having the display device, and more specifically relates to a display device having a light source such as a back light and a side light and a driving circuit which drives the light source, and a television receiver having the display device.

2. Description of the Related Art

A translucent liquid crystal display device, which is cited as an example of display devices, includes a liquid crystal display panel arranged to display an image and a light source unit disposed behind the liquid crystal display panel. Light emitted from the light source unit passes through the liquid crystal display panel, making an image displayed visible on a front side of the liquid crystal display panel. Such a display device has a plurality of circuit boards or FPC boards on which circuits arranged to drive the liquid crystal display panel and the light source unit are provided. The circuit boards or the FPC boards are brought into an electric connection with each other using cables, so that they can transmit and receive electric signals and electric power to and from each other.

To a peripheral portion of the liquid crystal display panel, TABs on which source drivers and gate drivers are mounted, and a printed circuit board on which other electronic or electric components are mounted are attached. A control circuit board that controls the source drivers and the gate drivers is placed on a back surface of the light source unit. The TABs and the printed circuit board are brought into electric connections with the control circuit board using cables such as FPC cables. Accordingly, the control circuit board transmits a control signal to the source drivers and the gate drivers, and the source drivers and the gate drivers drive the liquid crystal display panel based on the control signal.

The light source unit has lamps as light sources, one example of which includes fluorescent tubes such as cold cathode tubes and hot cathode tubes, and a light source driving circuit board that generates a driving voltage to be applied to the lamps, one example of which includes an inverter circuit board, where the lamps and the light source driving circuit board are brought into an electric connection.

The electric connection between the lamps and the light source driving circuit board is established in various ways. For example, there is known a configuration in which one electrode of a lamp as a light source is connected to a light source driving circuit board, the other electrode is connected to a return circuit board, and the return circuit board and a GND (ground) of the light source driving circuit board are connected using a return cable (see Japanese Patent Application Unexamined Publication No. 2004-191675).

In addition, there is known a configuration in which a plurality of lamps as light sources and two light source driving circuit boards are included, and the first light source driving circuit board drives one half of the lamps and the second light source driving circuit board drives the other half of the lamps. In this configuration, a connection of the half of the lamps to be driven by the first light source driving circuit board is established so that one electrode of each of the lamps receives driving voltages from the first light source driving circuit board, and the other electrode is connected to a GND of the second light source driving circuit board. In addition, a connection of the other half of the lamps to be driven by the second light source driving circuit board is established so that one electrode of each of the lamps receives driving voltages from the second light source driving circuit board, and the other electrode is connected to a GND of the first light source driving circuit board. The two light source driving circuit boards are connected to each other by a transmission cable such as a power cable, a return cable, and a cable that transmits a group of control signals to drive the lamps (see Japanese Patent Application Unexamined Publication No. 2004-191675).

In addition, there is known a configuration in which a control circuit board and a light source driving circuit board are brought into an electric connection so that a synchronizing signal of an image to be displayed on a liquid crystal display panel is transmitted to the light source driving circuit board (see Japanese Patent Application Unexamined Publication No. 2003-75804). In this configuration, pulse voltages to drive the lamps, which are generated by the light source driving circuit board, are synchronized with a vertical synchronizing signal or a horizontal synchronizing signal of the image to be displayed on the liquid crystal display panel, in order that wave noise appearing on a screen of the liquid crystal display panel is reduced.

In the configurations in which the light source driving circuit board and the return circuit board are brought into the electric connection, in which the two light source driving circuit boards are brought into the electric connection, and in which the control circuit board and the light source driving circuit board are brought into the electric connection, the circuit boards are brought into a direct electric connection using cables such as FPC cables. The light source driving circuit boards and the return circuit board are placed in peripheral portions of both ends of the lamps in consideration of being connected with the lamps. Especially, it is preferable that an electric wire arranged to transmit electric power from the light source driving circuit board to the lamps is made as short as possible in order to minimize a leak of electricity from the electric wire. Therefore, the light source driving circuit board is placed as close as possible to the ends of the lamps on a high voltage input side. For this reason, the light source driving circuit board and the return circuit board or the light source driving circuit boards are generally placed distant from each other as a consequence. In some cases, the control circuit board and the light source driving circuit board are also placed distant from each other.

In addition, there is known a configuration in which the lamps are connected in series and the voltages in opposite phases are applied to the lamps so as to drive them. Also in this configuration, the light source driving circuit board is placed as close as possible to the ends of the lamps on the high voltage input side for the same reasons as provided above.

When the circuit boards are brought into a direct electric connection using cables, there arises not only a problem of increases in the number of components and the number of assembly processes but also a problem of causing impediments to assembly such that the cables are unintentionally caught in the process of assembly. This is because, in accordance with recent increases in the size of the liquid crystal display panel, the distances between the circuit boards placed inside the display device, especially, the distance between the light source driving circuit boards are increased, and it is therefore necessary to increase the length of the cables. Thus, the cables are apt to be unintentionally caught.

### SUMMARY OF THE INVENTION

In order to overcome the problems described above, preferred embodiments of the present invention provide a display device in which an electric connection is established between light source driving circuit boards or between a light source driving circuit board and a control circuit board without using long cables, and a television receiver having the display device. The preferred embodiments of the present invention also provide a display device by which the number of components necessary for an electric connection between light source driving circuit boards or between a light source driving circuit board and a control circuit board can be reduced, and a television receiver having the display device.

According to the preferred embodiments of the present invention, a direct electric connection is established between a display panel circuit board such as a common circuit board attached to a peripheral portion of a display panel and a light source driving circuit board that drives light sources of the display panel, which allows transmission and reception of electric signals and transmission of electric power.

For the display device, an active matrix type display panel such as a TFT liquid crystal display panel is preferably used. For the display panel circuit board, a source side driving circuit board or a gate side driving circuit board arranged to drive the display panel is preferably used. The source side driving circuit board and the gate side driving circuit board refer to circuit boards to be attached directly or indirectly to the display panel along the peripheral portion of the display panel. The circuit board may define one circuit board or a combination of circuit boards. In addition, the circuit board includes not only a generally used hard circuit board which is made of bakelite or other synthetic resin materials, but also a circuit board prepared by placing necessary electronic or electric circuits on a flexible film, specifically, an SOF (System On Film).

For establishing the electric connection between the display panel circuit board and the light source driving circuit board, flexible electric connection mechanisms including electric cables such as FPC cables are preferably used.

Thus, in the display device according to a preferred embodiment of the present invention, the light source driving circuit board is arranged to receive a synchronizing signal and a gradient signal of an image to be displayed on the display panel and electric power supplied from a power supply circuit via the direct electric connection with the display panel circuit board.

It is also preferable that the display device according to a preferred embodiment of the present invention includes a plurality of light source driving circuit boards, and in such a case, the light source driving circuit boards allow transmission and reception of the electric signals via the direct electric connections with the display panel circuit board.

For example, the light source driving circuit boards are arranged to perform the transmission and reception of synchronizing signals to and from each other and synchronously drive the light sources based on the synchronizing signals. The light source driving circuit boards may be arranged so that voltages in opposite phases are applied to both ends of the light sources based on the synchronizing signals. In addition, the light source driving circuit boards may be arranged to receive the synchronizing signals of the image to be displayed on the display panel via the direct electric connections with the display panel circuit board, and drive the light sources in synchronization with the display panel based on the received synchronizing signals.

According to a preferred embodiment of the present invention, as compared to the conventional configuration in which the light source driving circuit boards are brought into the direct electric connection using transmission cables, the number of components and the number of assembly processes can be reduced because the transmission cables are unnecessary. Especially, the display panel circuit board attached to the peripheral portion of the display panel is placed close to the light source driving circuit board, and the distance between them is not affected by changing the size of the display panel. The conventional configuration in which the electric connection is established using the cables needs long cables due to the increases in the size of the display panel. The configuration according to preferred embodiments of the present invention does not have such a need. Therefore, the cables to be routed to the light source driving circuit board are not present, and impediments to assembly of the display device are not present.

In the configuration in which the active matrix type display panel such as a TFT liquid crystal display panel is used as the display panel, the circuit boards on which the source drivers and the gate drivers are mounted are attached to the peripheral portions of the display panel. Therefore, by bringing the circuit boards and the light source driving circuit board into electric connections, the number of components does not need to be increased.

By using the flexible electric connection mechanisms including the electric cables such as FPC cables in the electric connection between the display panel circuit board and the light source driving circuit board, the connecting work is facilitated.

According to the configuration in which the light source driving circuit board receives the synchronizing signal and the gradient signal of the image to be displayed on the display panel and the electric power from the power supply circuit via the direct electric connection with the display panel circuit board, a mechanism arranged to transmit the signals and a mechanism arranged to transmit the electric power can be integrated. As a result, the number of components and the number of assembly processes can be further reduced.

According to the configuration in which the plurality of the light source driving circuit boards are included and the light source driving circuit boards are brought into the electric connections via the display panel circuit board, long cables required for directly connecting the light source driving circuit boards become unnecessary because the light source driving circuit boards are placed close to the display panel circuit board.

According to the configuration in which the light source driving circuit boards transmit and receive the synchronizing signals therebetween and synchronously drive the light sources based on the synchronizing signals, the configuration in which the light source driving circuit boards receive the synchronizing signals of the image via the electric connection and drive the light sources in synchronization with the display panel, or the configuration in which the light source driving circuit boards receive the gradient signal of the image via the electric connection, the number of components and the number of assembly processes can be reduced and the structure of the display device can be simplified because the display panel circuit board is provided with the mechanism arranged to transmit those signals.

Other features, elements, characteristics and advantages of the present invention will become more apparent from the following detailed description of preferred embodiments with reference to the attached drawings.

### BRIEF DESCRIPTION OF THE DRAWINGS

FIG. 1 is an exploded perspective view schematically illustrating the structure of a display device according to a first preferred embodiment of the present invention.

FIG. 2 is a partial perspective view schematically illustrating the display device according to the first preferred embodiment in the process of assembly.

FIG. 3 is a view schematically illustrating a section of the display device according to the first preferred embodiment, which section relates to driving of lamps as light sources.

FIG. 4 is a timing chart illustrating driving timing of a liquid crystal display panel and the lamps as the light sources of the display device according to the first preferred embodiment.

FIG. 5 is a timing chart illustrating driving timing of the liquid crystal display panel and the lamps as the light sources of the display device according to the first preferred embodiment.

FIG. 6 is a view schematically illustrating a section of a display device according to a second preferred embodiment of the present invention, which section relates to driving of lamps as light sources.

FIG. 7 is a view schematically illustrating a section of a display device according to a third preferred embodiment of the present invention, which section relates to driving of lamps as light sources.

FIG. 8 is an exploded perspective view schematically illustrating the structure of the display device according to the third preferred embodiment.

FIG. 9 is a partial perspective view schematically illustrating the display device according to the third preferred embodiment in the process of assembly.

FIG. 10 is a view schematically illustrating a section of a display device according to a fourth preferred embodiment of the present invention, which section relates to driving of lamps as light sources.

FIG. 11 is a view schematically illustrating a section of a display device according to a fifth preferred embodiment of the present invention, which section relates to driving of lamps as light sources.

FIG. 12 is a view schematically illustrating a section of a display device according to a sixth preferred embodiment of the present invention, which section relates driving of lamps as light sources.

FIG. 13 is a view schematically illustrating a section of a display device according to a seventh preferred embodiment of the present invention, which section relates to driving of lamps as light sources.

FIG. 14 is an exploded perspective view schematically illustrating the structure of a television receiver according to a preferred embodiment of the present invention.

FIG. 15 is a view schematically illustrating a modified preferred embodiment of the display device according to the present invention, specifically, a view schematically illustrating a section of a display device in which light source driving circuit boards and a gate side common circuit board are brought into an electric connection, which section relates to driving of lamps as light sources.

FIGS. 16A and 16B are views illustrating modified preferred embodiments of the display device according to the present invention. FIG. 16A is a view illustrating a display device in which one SOF (System On Film) is attached to a peripheral portion of a liquid crystal display panel. FIG. 16B is a view illustrating a display device in which a plurality of SOFs are attached to a peripheral portion of a liquid crystal display panel and the TABs overlap one another so as to be connected.

### DETAILED DESCRIPTION OF PREFERRED EMBODIMENTS

A detailed description of preferred embodiments of the present invention will now be given with reference to the accompanying drawings. According to the preferred embodiments of the present invention to be given below, a display device has a translucent liquid crystal display panel, light sources, a light source driving circuit board, and a common circuit board attached to a peripheral portion of the liquid crystal display panel, where a direct electric connection is established between the light source driving circuit board and the common circuit board. The light source driving circuit board transmits and receives given signals and electric power via the direct electric connection.

First, a description of the first preferred embodiment of the present invention will be provided. A display device according to the first preferred embodiment has one light source driving circuit board. A common circuit board is attached to a peripheral portion of a liquid crystal display panel, and a direct electric connection is established between the light source driving circuit board and the common circuit board. The light source driving circuit board is arranged to receive electric power to drive light sources and a synchronizing signal of an image to be displayed on a liquid crystal display panel via the direct electrical connection.

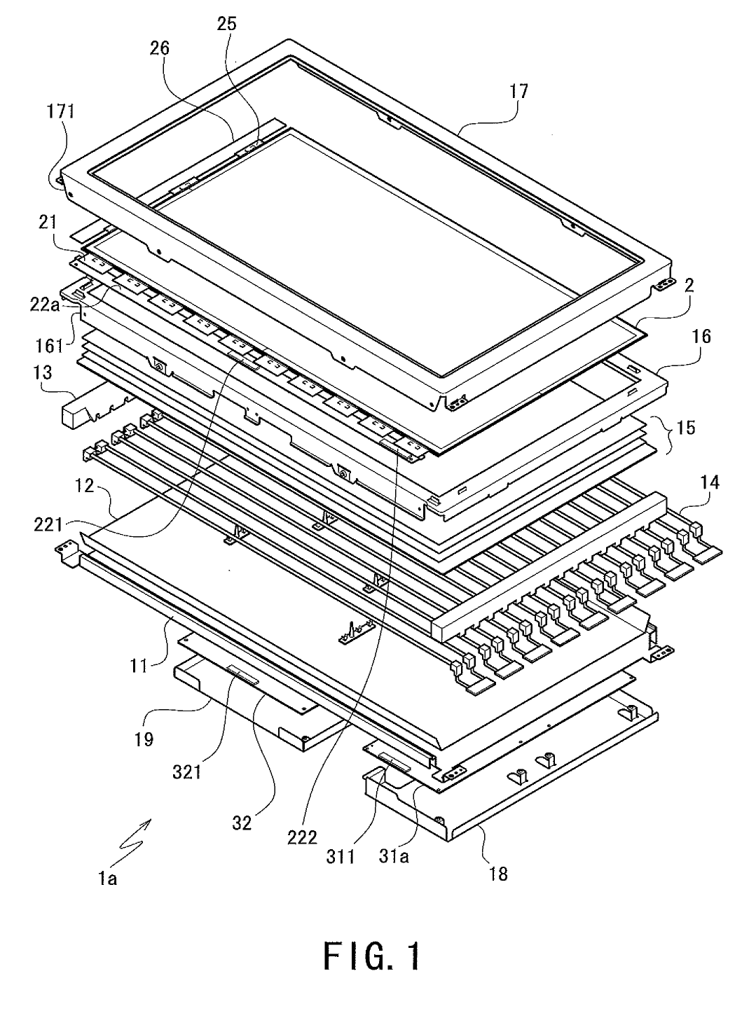

FIG. 1 is an exploded perspective view schematically illustrating the structure of the display device according to the first preferred embodiment of the present invention. In FIG. 1, the display device is illustrated so that its front surface faces toward the top of FIG. 1, and its back surface faces toward the bottom of FIG. 1, based on which the following descriptions will be provided.

First, a short summary of a configuration of a display device 1a according to the first preferred embodiment is given. The display device 1a includes a liquid crystal display panel 2 arranged to display an image, a control circuit board 32 arranged to produce a control signal for controlling the liquid crystal display panel 2, lamps 14 as light sources, and a light source driving circuit board 31a arranged to drive the lamps 14.

The display device 1a further includes a backlight chassis 11, side holders 13 attached to shorter edges of the backlight chassis 11, a reflection sheet 12 arranged to reflect light emitted from the lamps 14 diffusely, optical sheets 15 arranged to control the properties of the light, a frame 16 and a bezel 17 arranged to support the optical sheets 15 and the liquid crystal display panel 2, a light source driving circuit board cover 18 arranged to cover the light source driving circuit board 31a, and a control circuit board cover 19 arranged to cover the control circuit board 32.

Next, the constituent members of the display device 1a according to the first preferred embodiment will be described.

For the liquid crystal display panel 2, a translucent active matrix type liquid crystal display panel having a conventional structure is used. Therefore, detailed descriptions of the structure and operation of the liquid crystal display panel 2 are omitted. To one of the longer edges of the liquid crystal display panel 2, a plurality of TABs (Tape Automated Bonding) 21 on which drivers arranged to drive a source line (hereinafter referred to as “source drivers 47”) are mounted are attached. The TABs 21 are connected to a common circuit board (hereinafter referred to as a “source side common circuit board 22a”). In addition, to one of the shorter edges of the liquid crystal display panel 2, TABs 25 on which drivers arranged to drive a gate line (referred to as “gate drivers”) are mounted are attached. The TABs 25 are connected to a common circuit board (hereinafter referred to as a “gate side common circuit board 26”).

The common circuit boards 22a and 26 are long and thin. The common circuit boards 22a and 26 are arranged to distribute the control signal for controlling the liquid crystal display panel 2 that is produced by the control circuit board 32 to the source drivers 47 and the gate drivers.

In given positions on the source side common circuit board 22a, a first kind terminal section 221 and a second kind terminal section 222 are placed. The first kind terminal section 221 is arranged to establish an electric connection between the source side common circuit board 22a and the control circuit board 32. The second kind terminal section 222 is arranged to establish an electric connection between the source side common circuit board 22a and the light source driving circuit board 31a.

To be specific, the first kind terminal section 221 and the second kind terminal section 222 are preferably placed in positions such that the length of the electric connection becomes shortest when the electric connection of the source side common circuit board 22a with the control circuit board 32 or the light source driving circuit board 31a is established. The positions in which the first kind terminal section 221 and the second kind terminal section 222 are placed depend on positions of the constituent members in the display device 1a. The control circuit board 32 is generally placed in the middle of a back surface of the backlight chassis 11, and the first kind terminal section 221 is accordingly placed in the middle of the longitudinal direction of the source side common circuit board 22a. The light source driving circuit board 31a is generally placed in a peripheral portion of one of the shorter edges of the liquid crystal display panel 2 on the back surface of the backlight chassis 11, the second kind terminal section 222 is accordingly placed at an end portion in the longitudinal direction of the source side common circuit board 22a. An electric wire arranged to bring the first kind terminal section 221 and the second kind terminal section 222 into an electric connection is provided, of which a description will be provided later.

In the control circuit board 32, a control circuit that produces the control signal for controlling the liquid crystal display panel 2, precisely, the source drivers 47 and the gate drivers is established. The control signal includes a horizontal synchronizing signal and a vertical synchronizing signal of the image to be displayed. On the control circuit board 32, a control IC (not shown) that controls the source drivers 47 and the gate drivers, and other necessary electronic or electric components (not shown) are mounted, so that the control circuit is established. In addition, the control circuit board 32 includes a terminal section 321 arranged to establish a direct electric connection with the source side common circuit board 22a. For the control circuit board 32, a conventional control circuit board may be used, and a detailed description thereof is omitted.

The light source driving circuit board 31a is a circuit board in which an inverter circuit that generates high alternating voltages to drive the lamps 14, and other necessary electronic or electric circuits are established. On the light source driving circuit board 31a, a transistor for use in an inverter and other necessary electronic or electric components are mounted. In addition, the light source driving circuit board 31a includes a terminal section 311 arranged to establish a direct electric connection with the source side common circuit board 22a. For the light source driving circuit board 31a and the electronic or electric circuits established therein, conventional ones are used, and detailed descriptions thereof are omitted.

For the lamps 14, conventional lamps used in generally used display devices may be used. Examples of the conventional lamps include fluorescent tubes such as cold cathode tubes and hot cathode tubes, light emitting elements such as LEDs, and a light source assembly incorporating them. Hence, descriptions of the structure and operation of the lamps 14 are omitted. The lamps 14 included in the display device 1a shown in FIG. 1 are linear fluorescent tubes having electrodes at both ends. Also in the following descriptions, the fluorescent tubes having the electrodes at the both ends are preferably used as the lamps 14.

The backlight chassis 11 is a member shaped like a plate, which is preferably prepared by subjecting a metal plate material to press working. The side holders 13 are unitary molded members preferably made of a synthetic resin, which are substantially in the shape of a bar. The frame 16 and the bezel 17 are members preferably prepared by subjecting a metal plate material to press working. Side walls 161 and 171 are provided at the outer edges of the frame 16 and the bezel 17 so as to extend toward the back side. The light source driving circuit board cover 18 and the control circuit board cover 19 are covering elements arranged to cover the light source driving circuit board 31a and the control circuit board 32 respectively, and are preferably made of a metal plate material. For the optical sheets 15 and the reflection sheet 12, conventional ones used in generally used display devices are used, and detailed descriptions thereof are omitted.

Assembly of the display device 1a including the above-described constituent members will be described.

The reflection sheet 12 is laid on a front surface of the backlight chassis 11, and the lamps 14 are placed side by side on a front surface of the reflection sheet 12. The side holders 13 are attached thereto so as to be in alignment with the shorter edges of the backlight chassis 11 and to cover end portions of the lamps 14. The optical sheets 15 are placed on front surfaces of the backlight chassis 11 and the side holders 13, and the frame 16 is attached to a front surface of the optical sheets 15 so as to cover them.

The liquid crystal display panel 2 is placed on a front surface of the frame 16. The TABs 21 and 25 attached to the peripheral portions of the liquid crystal display panel 2 are bent toward the back side on the front surface of the frame 16 and the side wall 161, so that the common circuit boards 22a and 26 connected respectively to the TABs 21 and 25 are fixed to the outer surface of the side wall 161 of the frame 16. The light source driving circuit board 31a and the control circuit board 32 are installed on a back surface of the backlight chassis 11.

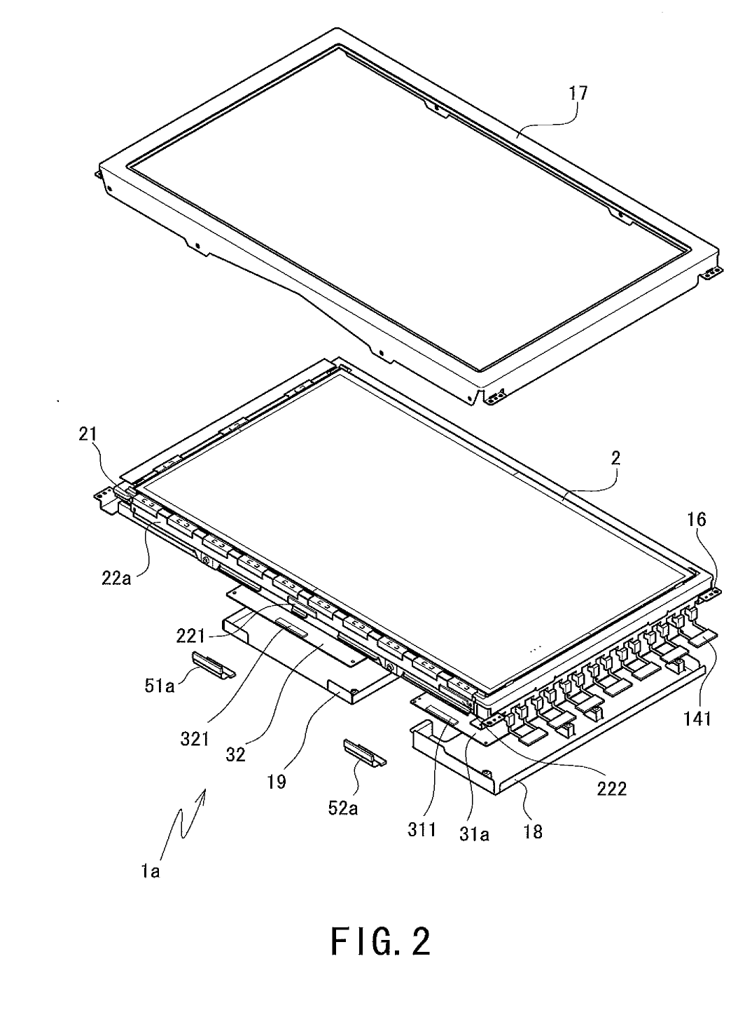

FIG. 2 is a view showing the assembly of the backlight chassis 11, the reflection sheet 12, the side holders 13, the lamps 14, the optical sheets 15, the frame 16, the liquid crystal display panel 2, the light source driving circuit board 31a and the control circuit board 32, where the source side common circuit board 22a is fixed to the side wall 161 of the frame 16.

In this state, the terminal section 321 of the control circuit board 32 and the first kind terminal section 221 of the source side common circuit board 22a are brought into a direct electric connection via an electric connection mechanism 51a. In addition, the terminal section 311 of the light source driving circuit board 31a and the second kind terminal section 222 of the source side common circuit board 22a are brought into a direct electric connection via an electric connection mechanism 52a. The first kind terminal section 221 and the second kind terminal section 222 of the source side common circuit board 22a are connected via the electric wire, and the light source driving circuit board 31a and the control circuit board 32 are brought into an electric connection via the source side common circuit board 22a. The electric connections will be specifically described later.

For the electric connection mechanism 51a arranged to connect the terminal section 321 of the control circuit board 32 and the first kind terminal section 221 of the source side common circuit board 22a and the electric connection mechanism 52a arranged to connect the terminal section 311 of the light source driving circuit board 31a and the second kind terminal section 222 of the source side common circuit board 22a, electric connection mechanisms generally used for transmission of electric signals and electric power such as flat cables, FPC cables and wire bundles are preferably used. The electric connection mechanisms 51a and 52a are preferably flexible in view of workability. In bringing the electric connection mechanisms 51a and 52 into electric connections respectively with the boards 32 and 31a, a connector, an anisotropic conductive film, or soldering are used.

One electrode of the lamp 14 is connected to the light source driving circuit board 31a, and the other electrode is grounded. The bezel 17, the light source driving circuit board cover 18 and the control circuit board cover 19 are further attached.

Basic operations of the display device 1a having the configuration as described above will be described. In FIG. 1, the control signal produced by the control circuit board 32 is transmitted to the source drivers 47 and the gate drivers, and the source drivers 47 and the gate drivers effect the operation of thin film transistors of the liquid crystal display panel 2 based on the control signal. In addition, the light emitted from the lamps 14 goes directly to the optical sheets 15 or is reflected diffusely by the reflection sheet 12 and goes to the optical sheets 15. The light is then transmitted through the optical sheets 15, so that the properties of the light are controlled by the optical sheets 15. The light of which the properties have been controlled is transmitted through the liquid crystal display panel 2. Thus, an image is displayed visible on a front side of the liquid crystal display panel 2.

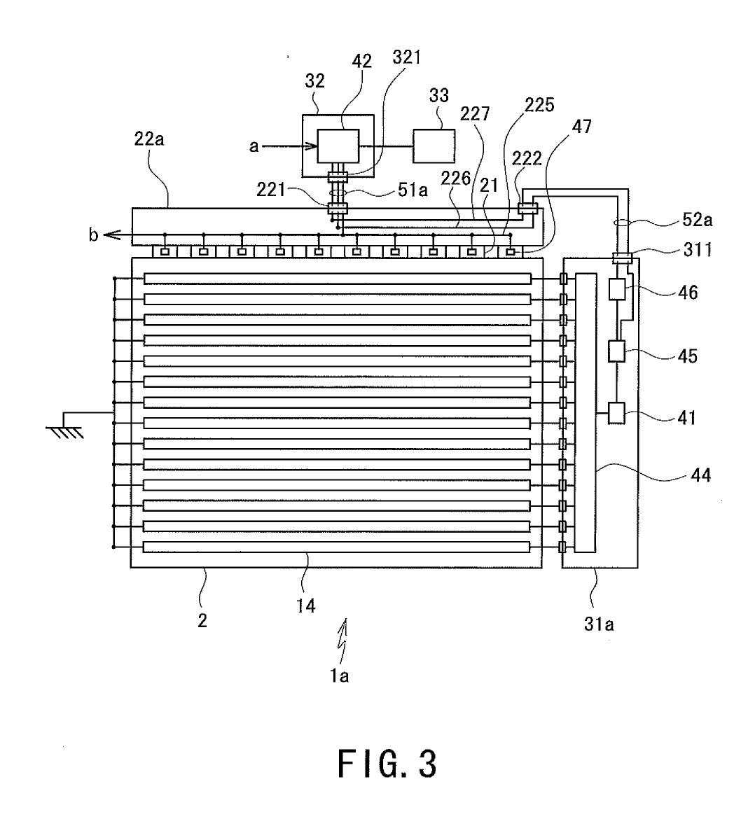

FIG. 3 is a view schematically illustrating a section of the display device 1a according to the first preferred embodiment, which section relates to the driving of the lamps 14.

As shown in FIG. 3, the electric wire between the first kind terminal section 221 and the second section terminal section 222 of the source side common circuit board 22a includes a horizontal synchronizing signal line 226 that transmits the horizontal synchronizing signal of the image and a vertical synchronizing signal line 227 that transmits the vertical synchronizing signal of the image. The source side common circuit board 22a includes a control signal line 225 arranged to distribute the control signal received from the control circuit board 32 to the source drivers 47 and the gate drivers. The control signal line 225 is not a single electric wire, but a set of parallel electric wires that transmit given signals.

A control circuit 42 is driven by electric power supplied from an external electric power supply 33, and produces the control signal based on an image signal “a” received from the outside. In FIG. 3, the arrow “a” schematically depicts the reception of the image signal.

The produced control signal is transmitted from the terminal section 321 of the control circuit board 32 to the source side common circuit board 22a via the electric connection mechanism 51a. Then, part of the control signal is distributed to the source drivers 47 via the control signal line 225 of the source side common circuit board 22a, and the other part is transmitted to the gate side common circuit board (not shown) so as to be distributed to the gate drivers. In FIG. 3, the arrow “b” schematically depicts the transmission of the control signal to the gate side common circuit board. The source drivers 47 and the gate drivers drive the thin film transistors of the liquid crystal display panel 2 based on the control signal.

The light source driving circuit board 31a includes a counter 46 for frequency division, a shift register 45 for frequency division, a light source driving circuit 41 that generates the high alternating voltages to be applied to the lamps 14, and a high voltage switching circuit 44 that controls timing of the application of the high alternating voltages.

The light source driving circuit 41 generates the high alternating voltages and outputs the high alternating voltages to the high voltage switching circuit 44. The counter 46 performs frequency division on the horizontal synchronizing signal received from the control circuit 42 and outputs shifting clocks obtained by the frequency division to the shift resistor 45. The shift resistor 45 performs frequency division on the shifting clocks received from the counter 46 based on the vertical synchronizing signal received from the control circuit 42. The high voltage switching circuit 44 applies the high alternating voltages received from the light source driving circuit 41 to the lamps 14 with given timing based on a signal received from the shift resistor 45.

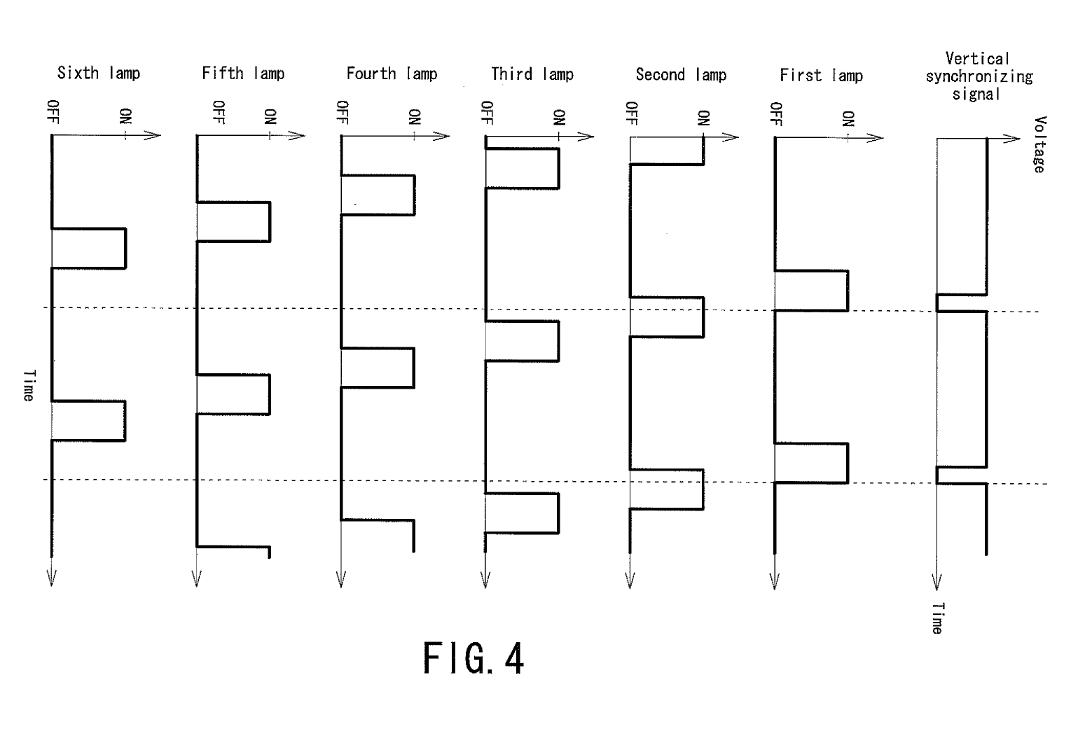

FIG. 4 is a timing chart illustrating relationships of the vertical synchronizing signal with switch-on timing and switch-off timing for the lamps 14. The term “n^{th} lamp” (n=1, 2, 3, 4, 5, 6 and so on) in FIG. 4 indicates that the lamp is the n^{th} one from the top of FIG. 3. As shown in FIG. 4, the lamps 14 are switched on and switched off such that the 1^{st} lamp, the 2^{nd} lamp, the 3^{rd} lamp and so on are successively switched on and off with shifted timing. By synchronizing the lamps 14 with the image to be displayed on the liquid crystal display panel 2, noise appearing on the screen can be reduced.

By synchronizing the lamps 14 with the image to be displayed on the liquid crystal display panel 2, blurriness caused by blooming is not present even if moving images are displayed. Operations of the display device according to the first preferred embodiment in such a case will be specifically described below.

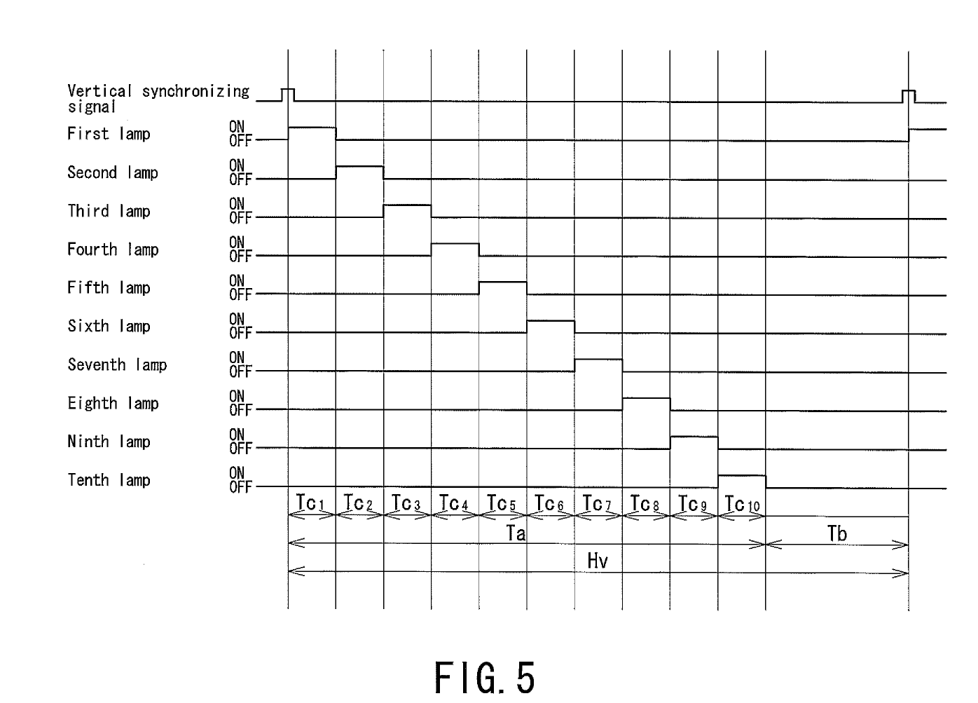

FIG. 5 is a timing chart illustrating switch-on timing of the lamps 14 of the display device 1a according to the first preferred embodiment. The term “n^{th} lamp” in FIG. 5 indicates that the lamp is the n^{th} one from the top of FIG. 3. In other words, the lamp is the n^{th} one from the upstream of a path through which gate pulses are applied respectively to a plurality of scanning lines provided to the display panel when the image is displayed on the display panel. FIG. 5 shows a configuration in which ten lamps as light sources are included (N=10). However, this is for the purpose of illustration, and the number of lamps is not limited in particular.

A period Tₐ, which is obtained by subtracting a vertical blanking period T_{b} (a period not used for image display) from a vertical scanning period Hv, is divided by N, the number of lamps, so as to obtain a period Tcₙ (n=1 to N), which is referred to as a “divided period” for the purpose of illustration. If the number of scanning lines provided to the liquid crystal display panel 2 is 480, the 1^{st} to the 48^{th} scanning lines are scanned during the first divided period Tc₁, and the 49^{th} to the 96^{th} scanning lines are scanned during the second divided period Tc₂. The same goes for the third divided period Tc₃ and later ones.

During the n^{th} divided period Tc₁, the n^{th} lamp is switched on so as to emit light, and the other lamps are switched off so as not to emit light. For example, during the first divided period Tc₁, the first lamp is switched on so as to emit light, and the other lamps are switched off so as not to emit light, and during the second divided period Tc₂, the second lamp is switched on so as to emit light, and the other lamps are switched off so as not to emit light.

In summary, during the period to scan the 1^{st} to the 48^{th} scanning lines (i.e., the first divided period Tc₁), the first lamp placed immediately below or in the vicinity of those scanning lines is switched on so as to emit light, and the other lamps are switched off so as not to emit light. During the period to scan the 49^{th} to the 96^{th} scanning lines (i.e., the second divided period Tc₂), the second lamp placed immediately below or in the vicinity of those scanning lines is switched on so as to emit light, and the other lamps are switched off so as not to emit light. As described above, the display device according to the first preferred embodiment operates in such a manner that the lamp placed immediately below or in the vicinity of the scanning lines scanned during each divided period Tcₙ is switched on so as to emit light, and the other lamps are switched off so as not to emit light. Thus, it is possible to prevent or control blurriness caused by blooming in moving images.

For the horizontal synchronizing signal line 226 and the vertical synchronizing signal line 227 between the first kind terminal section 221 and the second kind terminal section 222, independent electric wires are not necessarily required. The control signal line 225 is a set of parallel signal lines as mentioned above, in which electric wires that transmit the horizontal synchronizing signal and the vertical synchronizing signal to the source drivers 47 and the gate drivers are also included. Therefore, the electric wires that transmit the horizontal synchronizing signal and the vertical synchronizing signal included in the control signal line 225 may be drawn from the control signal line 225 to the second kind terminal section 222 via a through hole or other mechanisms. There is no problem if the horizontal synchronizing signal line 226 and the vertical synchronizing signal line 227 are provided independently for the transmission of the synchronizing signals to the light source driving circuit board 31a.

In a case where the horizontal synchronizing signal and the vertical synchronizing signal are to be transmitted to the light source driving circuit board 31a, the transmission of the synchronizing signals via the source side common circuit board 22a eliminates the necessity to establish a direct electric connection such as a cable connection between the control circuit board 32 and the light source driving circuit board 31a. Thus, no cables are to be installed between the control circuit board 32 and the light source driving circuit board 31a, and impediments to assembly are avoided. In addition, the number of components and the number of assembly processes can be reduced.

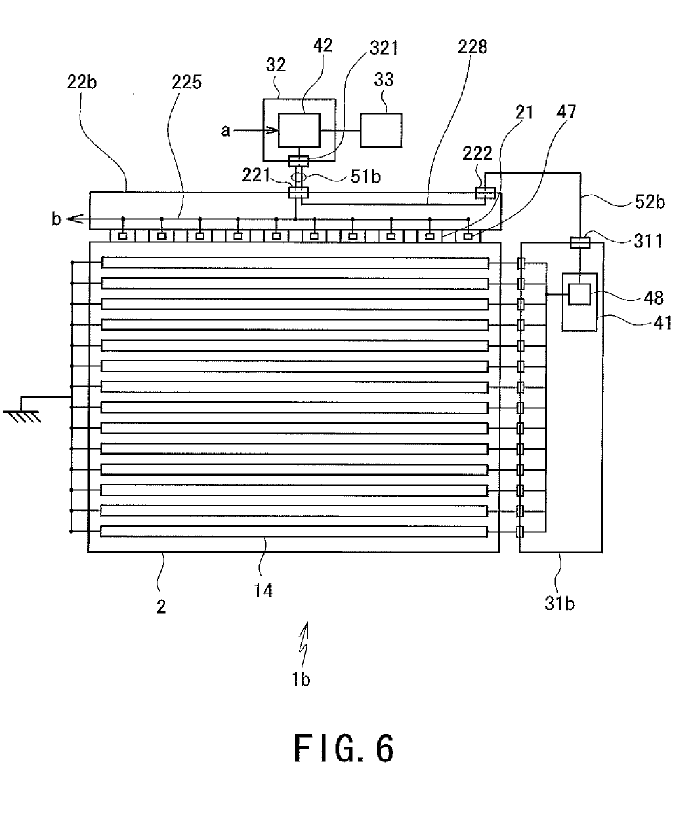

Next, a description of the second preferred embodiment of the present invention will be provided. In the description of the second preferred embodiment, the differences between the second preferred embodiment and the first preferred embodiment will be described. Descriptions of the same elements as the first preferred embodiment are omitted, and the same elements are assigned the same reference letters as the first preferred embodiment. FIG. 6 is a view schematically illustrating a section of a display device according to the second preferred embodiment, which section relates to the driving of the lamps 14.

As shown in FIG. 6, a display device 1b according to the second preferred embodiment includes the liquid crystal display panel 2, the control circuit board 32 that produces the control signal for controlling the liquid crystal display panel 2, the lamps 14, and a light source driving circuit board 31b that drives the lamps 14. To one of the longer edges of the liquid crystal display panel 2, the TABs 21 on which the source drivers 47 arranged to drive the source line are mounted are attached. The TABs 21 are connected to a source side common circuit board 22b.

The electric wire between the first kind terminal section 221 and the second kind terminal section 222 of the source side common circuit board 22b includes a gradient signal line 228 that transmits a gradient signal of the image. The source side common circuit board 22b includes the control signal line 225 arranged to distribute the control signal received from the control circuit board 32 to the source drivers 47 and the gate drivers. The control signal line 225 is not a single electric wire, but a set of parallel electric wires that transmit given signals.

The control circuit 42 is driven by electric power supplied from the external electric power supply 33, and produces the control signal based on the image signal “a” received from the outside. In FIG. 6, the arrow “a” schematically depicts the reception of the image signal. The control signal includes the gradient signal.

The produced control signal is transmitted to the source side common circuit board 22b from the terminal section 321 of the control circuit board 32 via an electric connection mechanism 51b. Then, part of the control signal is distributed to the source drivers 47 via the control signal line 225 of the source side common circuit board 22b, and the other part is transmitted to the gate side common circuit board (not shown) so as to be distributed to the gate drivers. In FIG. 6, the arrow “b” schematically depicts the transmission of the control signal to the gate side common circuit board. The source drivers 47 and the gate drivers drive the thin film transistors of the liquid crystal display panel 2 based on the control signal.

The light source driving circuit board 31b includes the light source driving circuit 41 that generates the high alternating voltages to be applied to the lamps 14. The light source driving circuit 41 includes a luminance control circuit 48. The luminance control circuit 48 calculates and determines luminance of the lamps 14 in each vertical scanning period based on the gradient signal included in the control signal.

The calculation is specifically performed in the following manners. The luminance control circuit 48 counts the number of high luminance pixels and the number of low luminance pixels in each vertical scanning period based on the gradient signal, and compares the number of high luminance pixels and the number of low luminance pixels. In accordance with a difference between the number of high luminance pixels and the number of low luminance pixels, the luminance control circuit 48 determines the luminance of the lamps 14 in the vertical scanning period. To be specific, if the number of high luminance pixels is larger in the vertical scanning period, the luminance of the lamps 14 is increased, and if the number of low luminance pixels is larger, the luminance of the lamps 14 is decreased.

The gradient signal produced by the control circuit 42 is transmitted to the luminance control circuit 48 of the light source driving circuit board 31b via the gradient signal line 228 of the source side common circuit board 22b. Owing to such a configuration, the action and effect the same as the first preferred embodiment can be exerted.

The gradient signal line 228 between the first kind terminal section 221 and the second kind terminal section 222 is not necessarily provided independently. The control signal line 225 is a set of parallel signal lines as mentioned above, in which an electric wire that transmits the gradient signal to the source drivers 47 is also included. Therefore, the electric wire that transmits the gradient signal included in the control signal line 225 may be drawn to the second kind terminal section 222 via a through hole or other mechanisms. There is no problem if the gradient signal line 228 is provided independently for the transmission of the gradient signal to the light source driving circuit board 31b.

The luminance control may be performed uniformly on all of the lamps 14 at a time in one vertical scanning period or may be performed on each of the lamps 14 in one vertical scanning period. For example, the luminance control may be performed in the configuration according to the first preferred embodiment in which the lamps 14 are controlled to emit light during their corresponding divided periods. In other words, the luminance control may be performed in such a manner that the number of high luminance pixels and the number of low luminance pixels in the pixels scanned during each of the divided periods are counted and compared, and in accordance with a difference between them, the luminance of the lamp 14 which is switched on so as to emit light in the divided period is controlled.

Next, a description of the third preferred embodiment of the present invention will be provided. In a display device according to the third preferred embodiment, the light source driving circuit receives electric power to drive the lamps via the source side common circuit board. In the description of the third preferred embodiment, the differences between the third preferred embodiment and the first or second preferred embodiment will be described. Descriptions of the elements the same as or similar to the first or the second preferred embodiment are omitted.

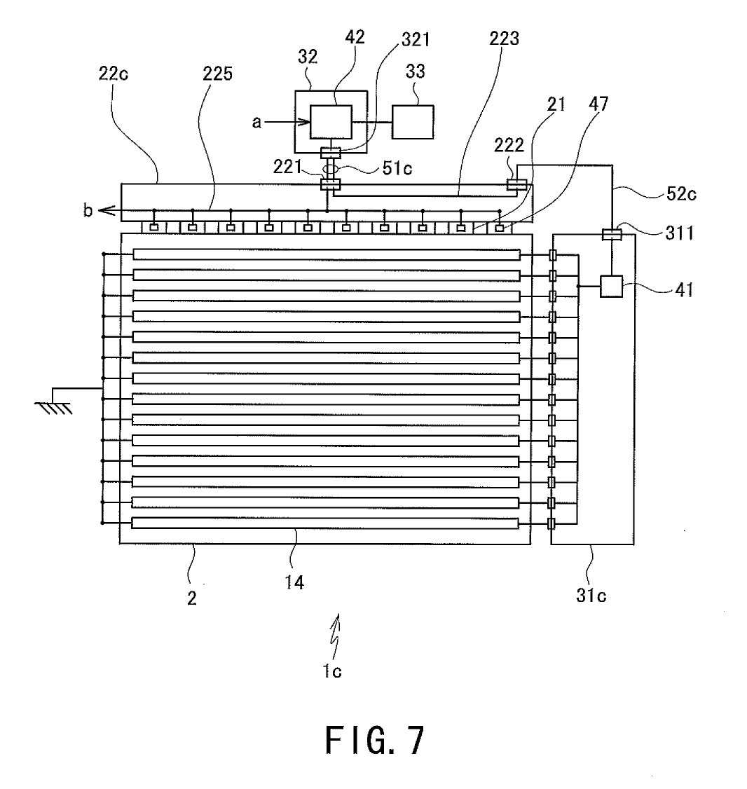

FIG. 7 is a view schematically illustrating the liquid crystal display panel 2 and a section of a display device 1c according to the third preferred embodiment, which section relates to the driving of the lamps 14. In the display device 1c, the electric wire between the first kind terminal section 221 and the second kind terminal section 222 of a source side common circuit board 22c includes an electric power supply line 223. The electric power supply line 223 is an electric wire arranged to supply electric power to drive the lamps 14 to a light source driving circuit board 31c.

The light source driving circuit board 31c is brought into an electrical connection with the source side common circuit board 22c via an electric connection mechanism 52c and the second kind terminal section 222. The light source driving circuit 41 of the light source driving board 31c receives electric power supplied from the external electric power supply 33 via the control circuit board 32, an electric connection mechanism 51c, the electric power supply line 223 of the source side common circuit board 22c, and the electric connection mechanism 52c. Upon the reception of the electric power, the light source driving circuit 41 generates and applies the high alternating voltages to the lamps 14.

According to such a configuration, it becomes unnecessary to route power supply cables between the external electric power supply 33 and the light source driving circuit board 31c, and the same action and effect as the first or the second preferred embodiments can be exerted.

The first to third preferred embodiments may be performed integrally, not independently. For example, the transmission of the electric power to drive the lamps and the horizontal and vertical synchronizing signals of the image to the light source driving circuit board 31a, 31b, 31c via the source side common circuit board 22a, 22b, 22c may be performed in the display device in which the lamps 14 are driven in synchronization with the image signal of the liquid crystal display panel 2. According to such a configuration, not only the same action and effect as the first to third preferred embodiments can be exerted, but also the number of components and the number of assembly processes can be further reduced as compared to the case of performing the first to third preferred embodiments independently because the electric connection mechanisms 51a, 51b and 51c, and the electric connection mechanisms 52a, 52b and 52c can be integrated.

Next, a description of the fourth preferred embodiment of the present invention will be provided. A display device according to the fourth preferred embodiment includes two light source driving circuit boards, where the light source driving circuit boards synchronously drive the lamps. In the description of the fourth preferred embodiment, the differences between the fourth preferred embodiment and the first, second or third preferred embodiment will be described, and descriptions of the elements the same as or similar to the first, second or third preferred embodiment are omitted.

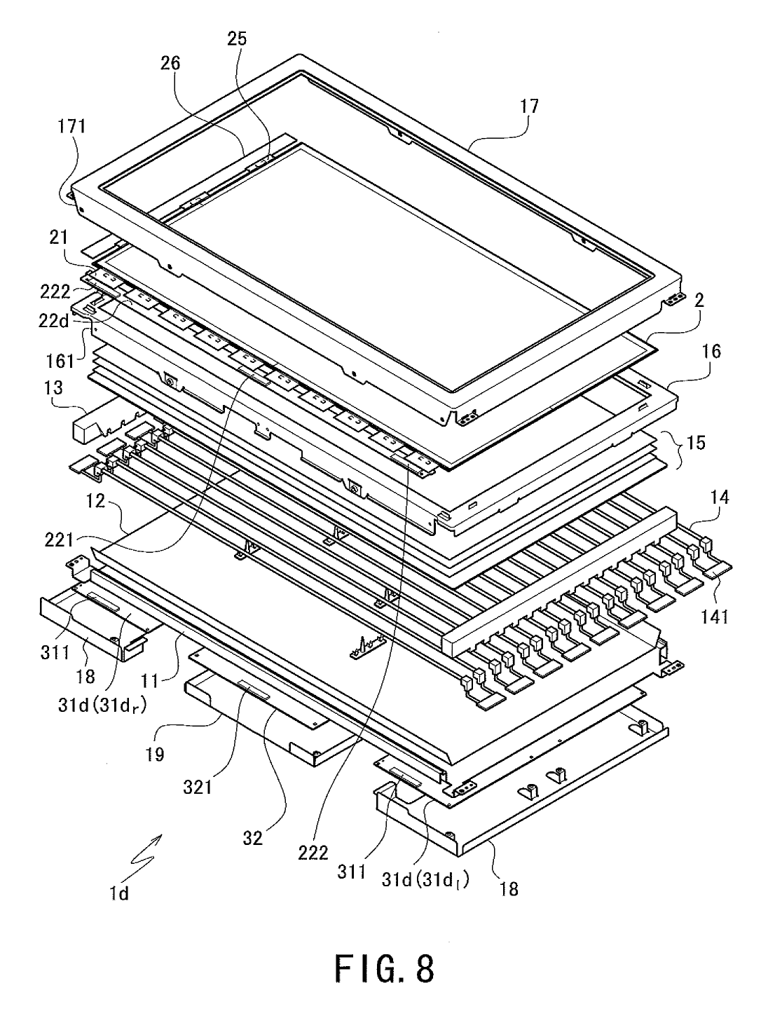

FIG. 8 is an exploded perspective view schematically illustrating the structure of the display device according to the fourth preferred embodiment. As shown in FIG. 8, a display device 1d according to the fourth preferred embodiment includes two light source driving circuit boards 31d (31d₁ and 31dᵣ). The light source driving circuit board covers 18 are arranged to cover the light source driving circuit boards 31d (31d₁ and 31dᵣ). While the circuit boards are respectively assigned the numerals 31d₁ and 31dᵣ for purposes of illustration, they are basically the same except for the configuration to be described later.

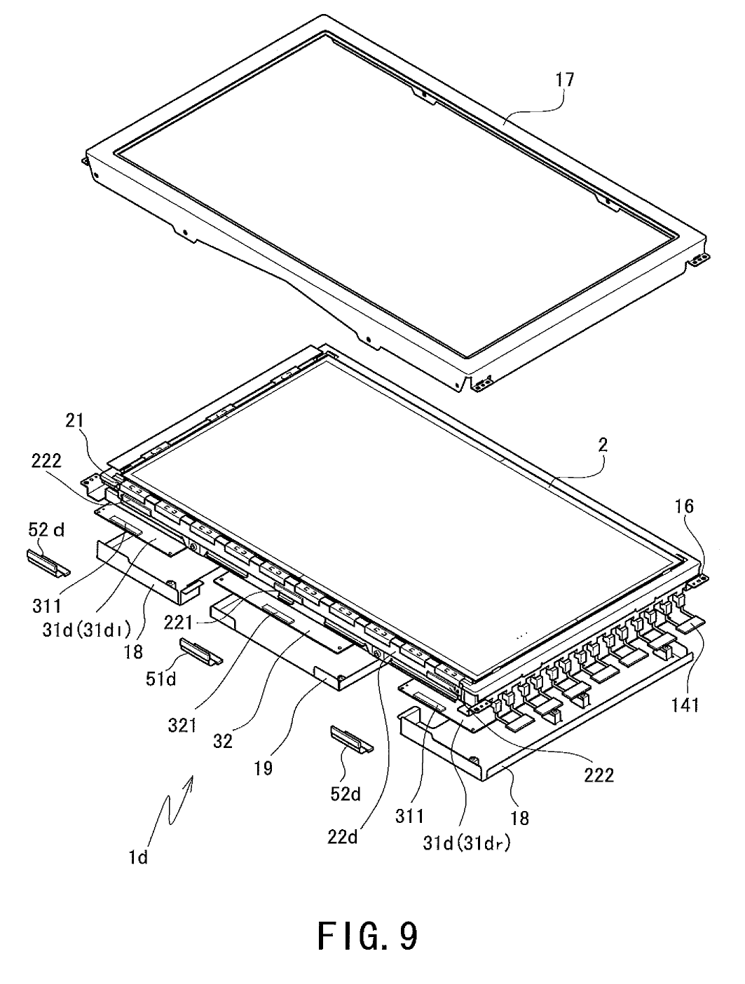

FIG. 9 is a perspective view schematically illustrating assembly of the display device according to the fourth preferred embodiment. As shown in FIG. 9, the second kind terminal sections 222 are placed at both end portions of a source side common circuit board 22d, and the second kind terminal sections 222 and the light source driving circuit boards 31d₁ and 31dᵣ are respectively brought into electric connections via electric connection mechanisms 52d. The display device 1d according to the fourth preferred embodiment is almost the same as the display device 1a, 1b or 1c according to the first, second or third preferred embodiment except for the configuration to be described later, and a description of the same configuration is omitted (see FIGS. 1 and 2 and the descriptions thereof for details).

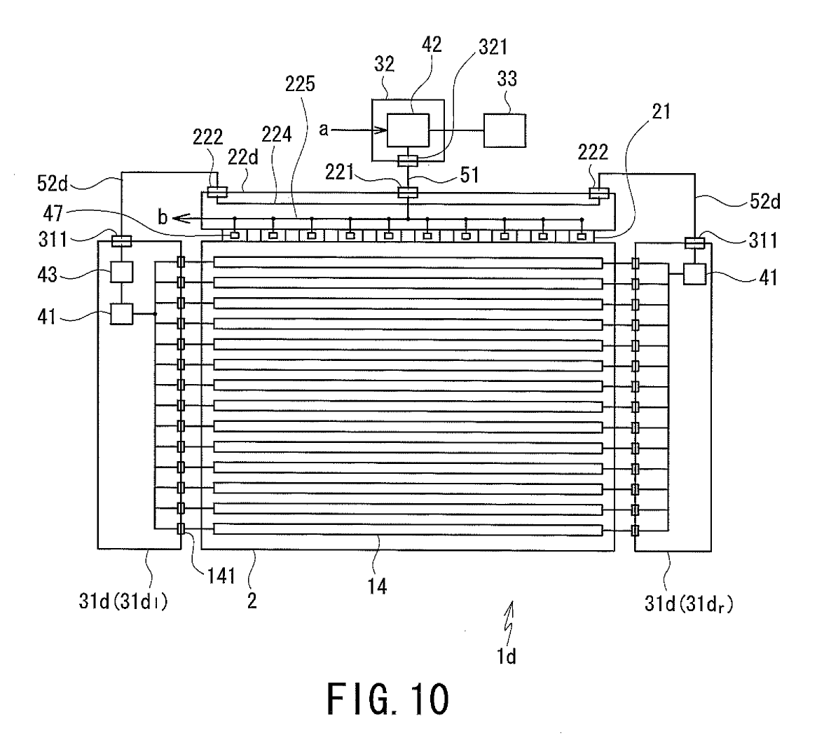

FIG. 10 is a view schematically illustrating the liquid crystal display panel 2 and a section of the display device 1d according to the fourth preferred embodiment, which section relates to the driving of the lamps 14.

As shown in FIG. 10, the source side common circuit board 22d attached to the liquid crystal display panel 2 of the display device 1d includes one first kind terminal section 221 and two second kind terminal sections 222. The second kind terminal sections 222 are preferably placed in positions such that lengths of the electric connections become shortest when the electric connections of the second kind terminal sections 222 with the light source driving circuit boards 31d₁ and 31dᵣ are established. In general, the second kind terminal sections 222 are preferably placed in the both end portions in the longitudinal direction of the source side common circuit board 22d. The second kind terminal sections 222 are connected via an electric wire. The electric wire includes a synchronizing signal line 224 that transmits and receives a synchronizing signal, which is described later.

The light source driving circuit boards 31d₁ and 31dᵣ include light source driving circuits 41 respectively. The light source driving circuits 41 synchronously operate and apply alternating voltages in opposite phases to the electrodes at the both ends of the lamps 14. In order to achieve this operation, an oscillating circuit 43 that produces a synchronizing signal is included in either of the two light source driving circuit boards 31d₁ and 31dᵣ (in FIG. 10, the light source driving circuit board 31d₁ shown on the left side), and the light source driving circuits 41 of the light source driving circuit boards 31d₁ and 31dᵣ generate the alternating voltages in opposite phases based on the synchronizing signal produced by the oscillating circuit 43. The light source driving circuit board 31dᵣ which does not include the oscillating circuit 43 receives and uses the synchronizing signal produced by the oscillating circuit 43 of the light source driving circuit board 31d₁. In other words, the synchronizing signal produced by the light source driving circuit board 31d₁ is transmitted to the light source driving circuit 41 of the light source driving circuit board 31dᵣ via the electric connection mechanism 52d, the source side common circuit board 22d, and the electric connection mechanism 52d.

The reason to use the two light source driving circuit boards 31d₁ and 31dᵣ so as to apply the alternating voltages in opposite phases to the electrodes at the both ends of the lamps 14 will be described. Owing to recent increases in the size of a liquid crystal display panel, there arises a necessity to use lamps of long length. Through fluorescent tubes used as the lamps, an alternating current flows during the driving of the fluorescent tubes. Therefore, if a member that is a conductor such as a backlight chassis is present close to the lamps on the back side of the lamps, capacity is generated between the lamps and the member, and a current leakage occurs. Therefore, in a configuration in which a high alternating voltage generated by a light source driving circuit is applied to one of the electrodes of the lamp and the other electrode is grounded (see the first and second preferred embodiments), the current flowing through the lamp is gradually decreased from the electrode to which the high alternating voltage is applied toward the electrode which is grounded. As a result, the luminance becomes lower toward the grounded side, and one side of the liquid crystal display panel becomes dark, so that the luminance becomes nonuniform in the lateral direction of the liquid crystal display panel.

Therefore, in order to prevent the lamps from becoming dark on one side, alternating voltages in opposite phases are applied to the both ends of the lamps. In this case, the light source driving circuits need to be driven synchronously so that the alternating voltages outputted from the two light source driving circuit boards are kept in opposite phases. For these reasons, the oscillating circuit 43 that produces the synchronizing signal is provided to either of the two light source driving circuit boards 31d₁ and 31dᵣ (in the fourth preferred embodiment, the light source driving circuit board 31d₁), the two light source driving circuit boards 31d₁ and 31dᵣ are connected to each other so as to be capable of transmitting and receiving the synchronizing signals from and to each other, and the light source driving circuits 41 of the light source driving circuit boards 31d₁ and 31dᵣ share the synchronizing signal.

The light source driving circuit boards 31d₁ and 31dᵣ are generally placed in peripheral portions of the shorter edges of the liquid crystal display panel 2 on the back surface of the backlight chassis 11 in consideration of connectivity with the lamps 14. In accordance with recent increases in the size of the liquid crystal display panel 2, a distance between the light source driving circuit boards 31d₁ and 31dᵣ is also increased. Therefore, in the conventional configuration in which the light source driving circuit boards 31d₁ and 31dᵣ are brought into a direct electric connection using cables, the cables becomes necessarily longer.

However, even if the size of the liquid crystal display panel 2 increases, the distance between the source side common circuit board 22d and the light source driving circuit board 31d₁ or 31dᵣ is not directly influenced by the increase while the length of the source side common circuit board 22b becomes longer. In other words, regardless of the size of the liquid crystal display panel 2, the both end portions of the source side common circuit board 22d are located close to the light source driving circuit boards 31d₁ and 31dᵣ respectively. Therefore, according to the configuration of the fourth preferred embodiment, cables such as FPC cables arranged to connect the second kind terminal sections 222 of the source side common circuit board 22d and the terminal sections 311 of the light source driving circuit boards 31d₁ and 31dᵣ may be extremely short. As a result, the necessity of long cables is eliminated so as to avoid the presence of factors of putting impediments to assembly, and the electric connection mechanisms cannot be impediments to assembly.

Next, a description of the fifth preferred embodiment of the present invention will be provided. A display device according to the fifth preferred embodiment includes two light source driving circuit boards and two light source driving circuits, and the light source driving circuits generate alternating voltages in opposite phases, receive a synchronizing signal via a source side common circuit board, and operate in synchronization with the liquid crystal display panel. In other words, the first preferred embodiment is modified to include two light source driving circuit boards. Hereinafter, the differences between the fifth preferred embodiment and the first, second, third or fourth preferred embodiment will be described, and descriptions of the elements the same as or similar to the first, second, third or fourth preferred embodiment are omitted.

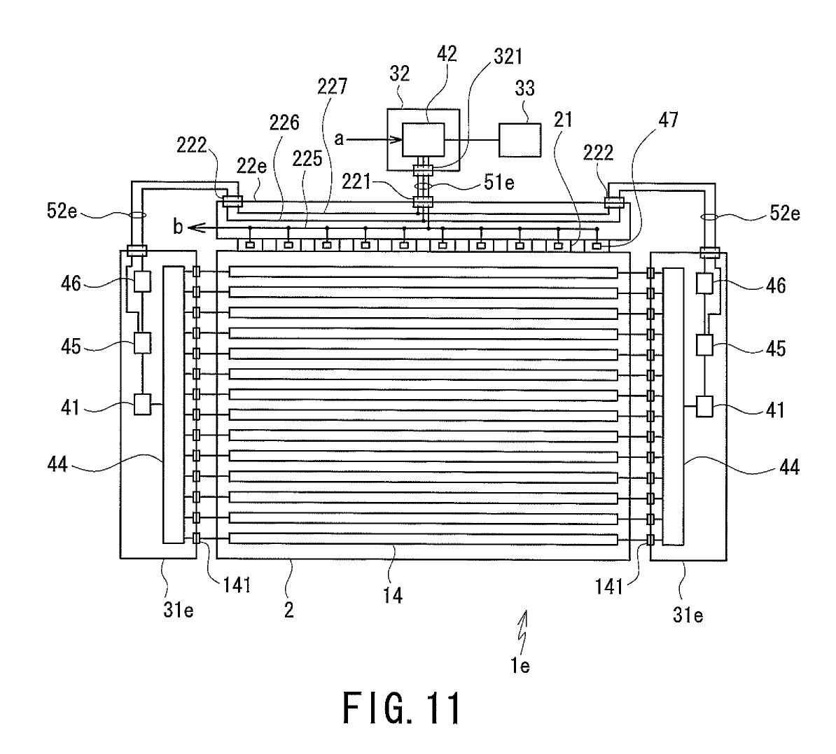

FIG. 11 is a view schematically illustrating a section of a display device 1e according to the fifth preferred embodiment, which section relates to the driving of the lamps 14. As shown in FIG. 11, one first kind terminal section 221 and two second kind terminal sections 222 are provided to a source side common circuit board 22e. An electric wire is provided between the first kind terminal section 221 and the second kind terminal sections 222. The electric wire includes the horizontal synchronizing signal line 226 that transmits the horizontal synchronizing signal and the vertical synchronizing signal line 227 that transmits the vertical synchronizing signal. Thus, the horizontal and vertical synchronizing signals can be received from the control circuit 42 via the first kind terminal section 221 so as to be transmitted to the both second kind terminal sections 222. The first kind terminal section 221 and the second kind terminal sections 222 are preferably placed in the same positions as the fourth preferred embodiment.

Light source driving circuit boards 31e of the display device 1e has almost the same configuration as the light source driving circuit board 31a according to the first preferred embodiment. In addition, in the light source driving circuit boards 31e, high alternating voltages in opposite phases are generated in the same manner as the light source driving circuit boards 31d (31d₁ and 31dᵣ) according to the fourth preferred embodiment. The light source driving circuits 41 generate the high alternating voltages in opposite phases and apply the high alternating voltages in opposite phases to the electrodes at the both ends of the lamps 14. The operations of the display device 1e are almost the same as the display device 1a according to the first preferred embodiment except that the light source driving circuit boards 31e generate the high alternating voltages in opposite phases, and are almost the same as the display device 1d according to the fourth preferred embodiment in respect of generating the high alternating voltages in opposite phases. Therefore, a detailed description thereof is omitted (see FIG. 4 and the descriptions thereof).

Owing to such a configuration that the light source driving circuits 41 receive the horizontal and vertical synchronizing signals via the source side common circuit board 22e, the necessity of establishing direct electric connections between the light source driving circuit boards 31e and the control circuit board 32 is eliminated, and the same action and effect as the first to fourth preferred embodiments can be exerted.

Next, a description of the sixth preferred embodiment of the present invention will be provided. A display device according to the sixth preferred embodiment includes two light source driving circuit boards and two light source driving circuits, and the light source driving circuits generate alternating voltages in opposite phases and receive a gradient signal via a source side common circuit board. The light source driving circuits control the luminance of the lamps based on a gradient of an image to be displayed on the liquid crystal display panel. In other words, the second preferred embodiment and the fourth preferred embodiment are combined. Hereinafter, the differences between the sixth preferred embodiment and the first, second, third, fourth or fifth preferred embodiment will be described, and descriptions of the elements the same as or similar to the first, second, third, fourth or fifth preferred embodiment are omitted.

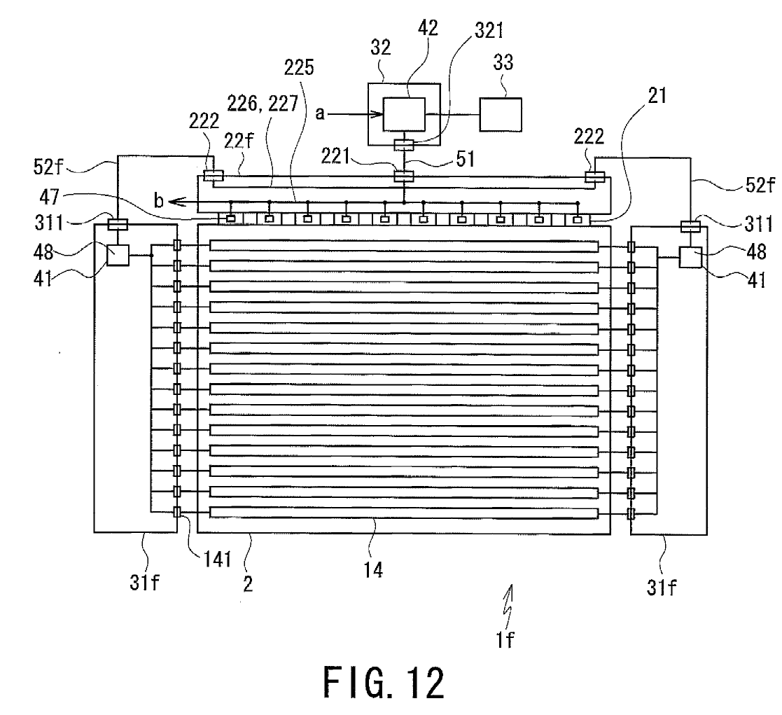

FIG. 12 is a view schematically illustrating a section of a display device 1f according to the sixth preferred embodiment, which section relates to the driving of the lamps 14. As shown in FIG. 12, one first kind terminal section 221 and two second kind terminal sections 222 are provided to a source side common circuit board 22f. An electric wire is provided between the first kind terminal section 221 and the second kind terminal sections 222. The electric wire includes the horizontal synchronizing signal line 226 that transmits the horizontal synchronizing signal and the vertical synchronizing signal line 227 that transmits the vertical synchronizing signal. Thus, the horizontal and vertical synchronizing signals can be received from the control circuit 42 via the first kind terminal section 221 so as to be transmitted to the both second kind terminal sections 222. The first kind terminal section 221 and the second kind terminal sections 222 are preferably placed in the same positions as the display device 1d according to the fourth preferred embodiment.

Light source driving circuit boards 31f of the display device 1f has almost the same configuration as the light source driving circuit board 31a according to the first preferred embodiment. In addition, in the light source driving circuit boards 31f, high alternating voltages in opposite phases are generated and applied to the electrodes at the both ends of the lamps 14 in the same manner as the light source driving circuit boards 31d (31d₁ and 31dᵣ) according to the fourth preferred embodiment and the light source driving circuit boards 31e according to the fifth preferred embodiment. The operations of the display device 1f are almost the same as the display device 1a according to the first preferred embodiment except that the light source driving circuit boards 31f generate the high alternating voltages in opposite phases, and are almost the same as the display devices 1d and 1e according to the fourth and fifth preferred embodiments in respect of generating the high alternating voltages in opposite phases. Therefore, detailed descriptions of the operations of the display device 1f are omitted (see FIG. 5 and the descriptions thereof).

Owing to such a configuration that the light source driving circuits 41 receive the horizontal and vertical synchronizing signals via the source side common circuit board 22f, the necessity of establishing direct electric connections between the light source driving circuit boards 31f and the control circuit board 32 is eliminated, and the same action and effect as the first to fifth preferred embodiments can be exerted.

Next, a description of the seventh preferred embodiment of the present invention will be provided. A display device according to the seventh preferred embodiment of the present invention includes two light source driving circuit boards, and the light source driving circuits receive electric power to drive the lamps 14 via a source side common circuit board. In other words, the third preferred embodiment is modified to include two light source driving circuit boards. Since the configuration in which the light source driving circuit board receives the electric power via the source side common circuit board has been described in the second preferred embodiment, here will be provided a description of a configuration in which the light source driving circuit boards receive the electric power via the source side common circuit board as well as being synchronously driven by the source side common circuit board. In other words, the fourth preferred embodiment and the third preferred embodiment are combined. Hereinafter, the differences between the seventh preferred embodiment and the first, second, third, fourth, fifth or sixth preferred embodiment will be described, and descriptions of the elements the same as or similar to the first, second, third, fourth, fifth or sixth preferred embodiment are omitted.

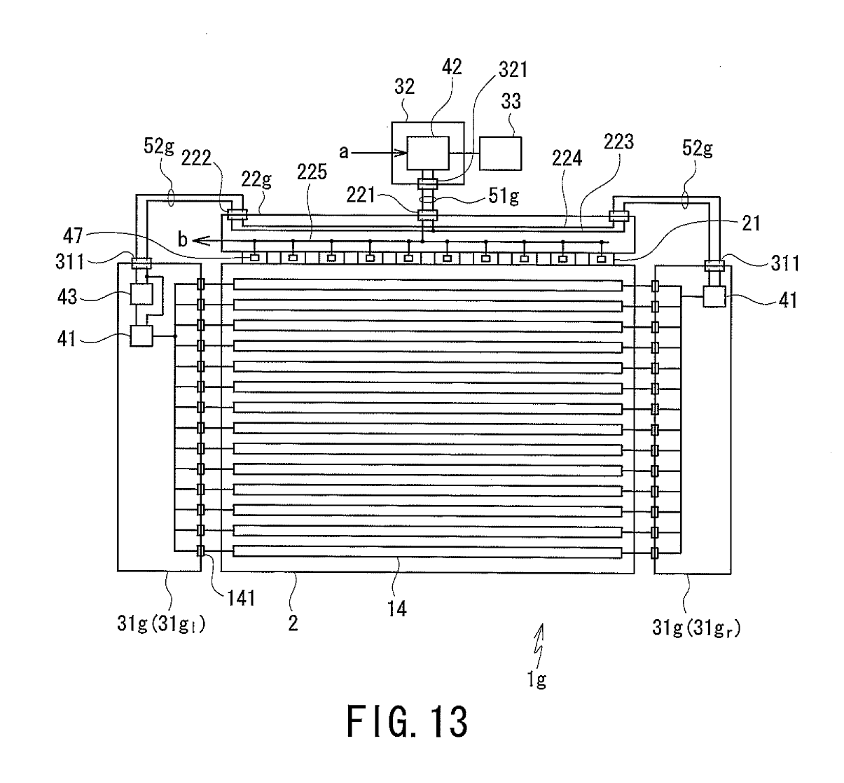

FIG. 13 is a view schematically illustrating a section of a display device 1g according to the seventh preferred embodiment of the present invention, which section relates to the driving of the lamps 14. As shown in FIG. 13, one first kind terminal section 221 and two second kind terminal sections 222 are provided to a source side common circuit board 22g of the display device 1g. An electric wire is provided between the first kind terminal section 221 and the second kind terminal sections 222 and between the second kind terminal sections 222. The electric wire between the first kind terminal section 221 and the second kind terminal sections 222 includes the electric power supply line 223 that transmits the electric power to drive the lamps 14. The electric wire between the second kind terminal sections 222 includes the synchronizing signal line 224 that transmits the synchronizing signal.

Thus, light source driving circuit boards 31g₁ and 31gᵣ can receive the electric power to drive the lamps 14 from the external electric power supply 33 via the source side common circuit board 22g. In addition, the light source driving circuit board 31gᵣ which does not include the oscillating circuit 43 can receive the synchronizing signal produced by the oscillating circuit 43 of the light source driving circuit board 31g₁ via the source side common circuit board 22g.

Since the operations of the display device 1g having such a configuration are almost the same as the display device 1d according to the fourth preferred embodiment, detailed descriptions thereof are omitted. According to such a configuration, not only the same action and effect as the fourth preferred embodiment can be exerted, but also the number of components and the number of assembly processes can be reduced because the transmission of the electric power to the light source driving circuit boards 31g₁ and 31gᵣ and the transmission and reception of the synchronizing signal to and from the light source driving circuit boards 31g₁ and 31gᵣ can be integrated. As a result, factors putting impediments to assembly (the presence of long cables) can be reduced more efficiently.

In the seventh preferred embodiment, the configuration in which the transmission of the electric power and the transmission and reception of the synchronizing signal are integrated has been described. However, they are not necessarily integrated. In the fifth preferred embodiment, the description of the transmission of the electric power to the light source driving circuit boards is omitted. However, the transmission of the electric power and the transmission and reception of the vertical and horizontal synchronizing signals may be integrated also in the fifth preferred embodiment as in the seventh preferred embodiment.

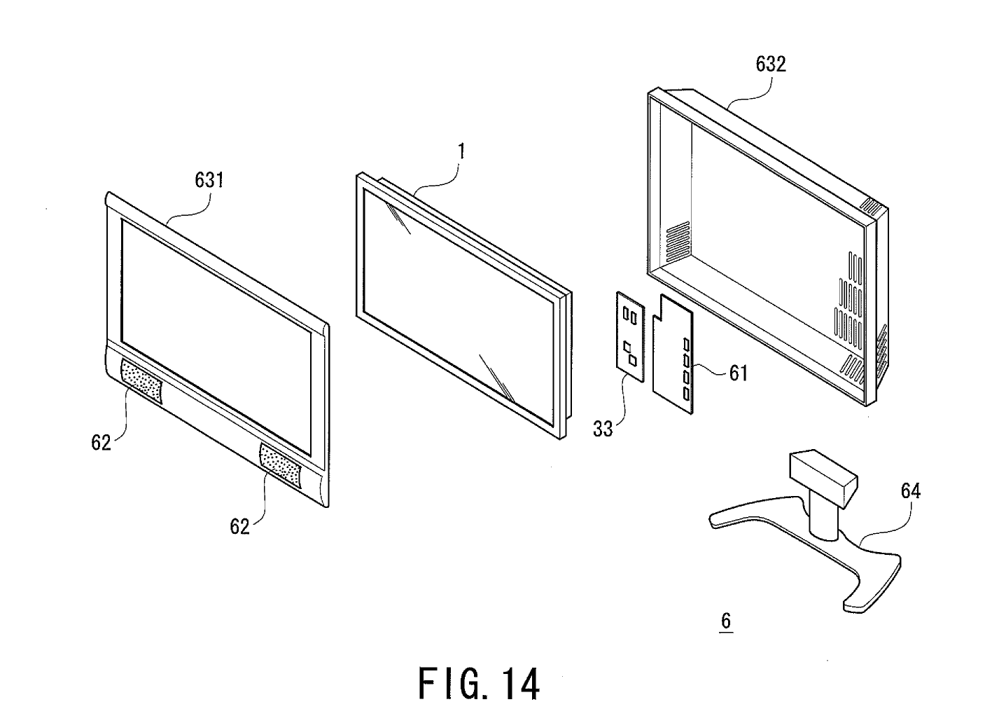

Next, a description of a television receiver according to a preferred embodiment of the present invention will be provided. FIG. 14 is an exploded perspective view schematically illustrating the structure of the television receiver according to the present preferred embodiment.

A television receiver 6 includes a tuner 61 that produces an image signal and a sound signal of a given channel based on received radio waves, a display device 1 that displays an image based on the image signal produced by the tuner 61, loudspeaker mechanisms 62 that produce a sound based on the sound signal produced by the tuner 61, and the electric power supply 33 that supplies electric power to the tuner 61, the display device 1 and the loudspeaker mechanisms 62.

For the tuner 61, a conventional terrestrial tuner, a BS tuner, or a CS tuner can be used. For the loudspeaker mechanisms 62, a variety of loudspeaker mechanisms such as a generally used loudspeaker can be used. Hence, detailed descriptions thereof are omitted. For the display device 1, the display device according to any one of the preferred embodiments described above can be used. As shown in FIG. 14, the display device 1, the tuner 61, the loudspeaker mechanisms 62 and the electric power supply 33 are housed in cabinets 631 and 632 so as to be supported by a supporting member 64. Alternatively, the tuner 61, the loudspeaker mechanisms 62 and the electric power supply 33 are mounted on the display device 1.

The foregoing descriptions of preferred embodiments and the implementation example of the present invention have been presented for purposes of illustration and description with reference to the drawings. However, it is not intended to limit the present invention to the preferred embodiments, and modifications and variations are possible as long as they do not deviate from the principles of the present invention.

In the preferred embodiments as described above, the liquid crystal display panel is preferably used as the display panel. However, the kind of the display panel is not limited if a display panel circuit board is attached to the display panel along the peripheral portion of the display panel. Since an active matrix type display panel generally has such a configuration, not only the liquid crystal display panel but also an active matrix type display panel are preferably used.

In addition, while the light source driving circuit board and the control circuit board are brought into direct electric connections with the source side common circuit board in the preferred embodiments as described above, they may be brought into direct electric connections with the gate side common circuit board.

In general, the liquid crystal display panel is rectangular, where the source signal is inputted from the longer edge side, and the gate drivers are driven from the shorter edge side. Accordingly, the source side common circuit board is attached to the longer edge, and the gate side common circuit board is attached to the shorter edge. When used in the television receiver, the liquid crystal display panel is placed horizontally long with its longer edges placed horizontal. As for the lamps, they are usually placed with their center lines placed horizontal. Thus, as described in the preferred embodiments, the lamps and the source side common circuit board are placed substantially in parallel, and the light source driving circuit board is placed in the peripheral portion of the shorter edge of the liquid crystal display panel. According to such a configuration, a direct electric connection is established between the source side common circuit board and the light source driving circuit board, and the action and effect as described in the preferred embodiments can be exerted.

However, the liquid crystal display panel is sometimes placed vertically long with its shorter edges placed horizontal. For example, a display for wall advertisements is used in such a manner. In this case, the horizontal placement of the lamps makes a positional relationship of the source side common circuit board and the gate side common circuit board with respect to the light source driving circuit board opposite to the preferred embodiments of the present invention. In order to exert the action and effect as described in the preferred embodiments, a direct electric connection needs to be established between the light source driving circuit board and the gate side common circuit board.

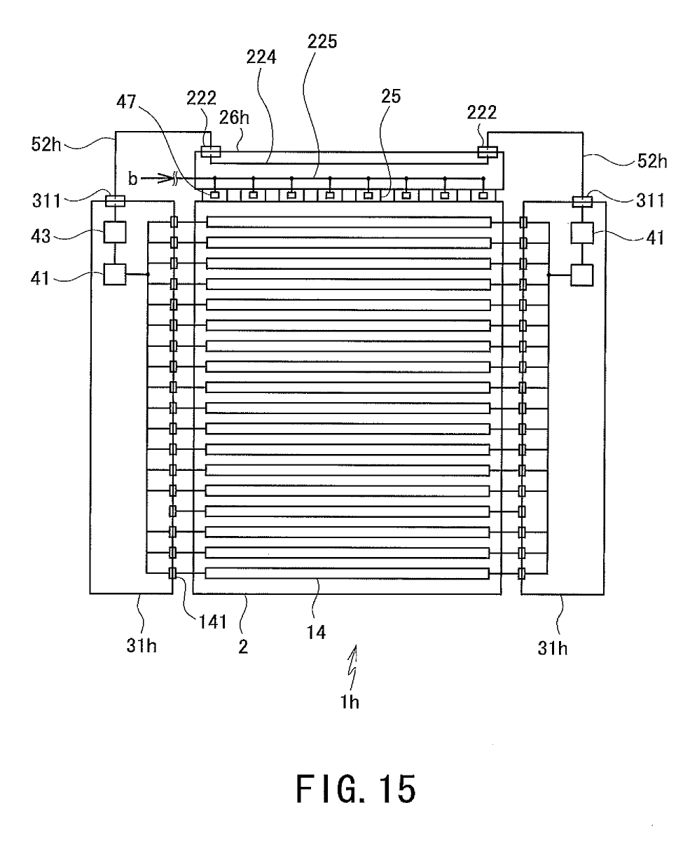

FIG. 15 is a view schematically illustrating a display device 1h in which light source driving circuit boards 31h are brought into direct electric connections with a gate side common circuit board 26h. In other words, the fourth preferred embodiment is modified such that the liquid crystal display panel 2 is placed vertically long.

A brief explanation of this configuration will be provided. The TABs 25 on which the gate drivers are mounted are attached to one of the shorter edges of the liquid crystal display panel 2, and the TABs 25 are connected to a gate side common circuit board 26h. The gate side common circuit board 26h receives the control signal from the source side common circuit board (not shown), and distributes the control signals to the gate drivers. In FIG. 15, the arrow “b” schematically depicts the transmission of the control signal from the source side common circuit board. In addition, at both end portions in the longitudinal direction of the gate side common circuit board 26h, the second kind terminal sections 222 are placed. An electric wire (the synchronizing signal line 224) is provided between the second kind terminal sections 222 so that the synchronizing signals are transmitted and received. In addition, the light source driving circuit boards 31h are placed in peripheral portions of the longer edges of the liquid crystal display panel 2. The light source driving circuit boards 31h are brought into direct electric connections with the gate side common circuit board 26h by electric connection mechanisms 52h.

The display device 1h as described above operates in a similar manner to the display device 1d according to the fourth preferred embodiment, and the same action and effect as the display device 1d according to the fourth preferred embodiment can be exerted. Instead of applying the display device 1h to the fourth preferred embodiment, the display device 1h may be applied to the other preferred embodiments of the present invention. In short, the gate side common circuit board and the source side common circuit board change only their places. Therefore, it is enough if the source side common circuit board is read as the gate side common circuit board in the above descriptions of the preferred embodiments of the present invention.

In the preferred embodiments of the present invention, the TABs are attached to the peripheral portion of the liquid crystal display panel, and the electric signals and the electric power are transmitted via the common circuit board connected to the TABs. However, the common circuit board and the TABs attached to the peripheral portion of the liquid crystal display panel are not limited thereto.

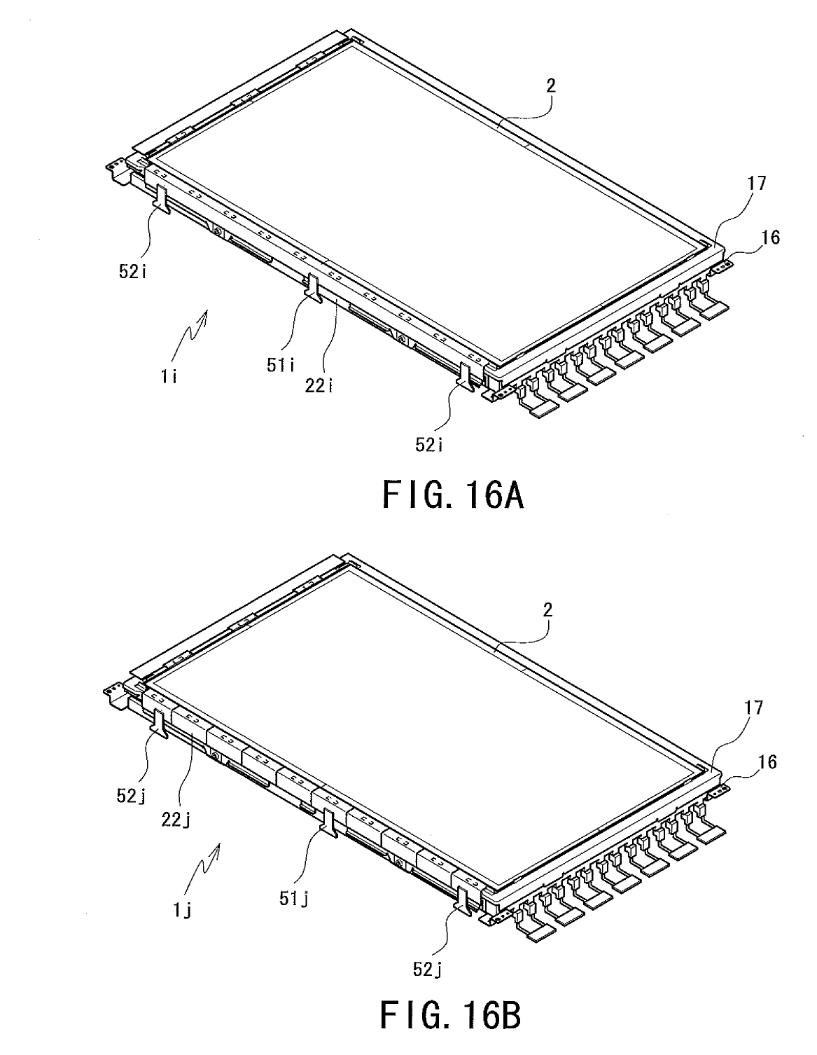

FIGS. 16A and 16B are views showing modified preferred embodiments of the circuit board attached to the peripheral portion of the liquid crystal display panel 2. FIG. 16A is a view illustrating one of the modified preferred embodiments in which one SOF (System On Film) 22i is attached to the peripheral portion of the liquid crystal display panel 2. FIG. 16B is a view illustrating the other modified preferred embodiment in which a plurality of SOFs 22j are attached to the peripheral portion of the liquid crystal display panel 2. The configurations shown in FIGS. 16A and 16B correspond to the configuration shown in FIG. 9, but the bezel is not shown in FIGS. 16A and 16B.

In the modified preferred embodiment shown in FIG. 16A, the SOF 22i is attached to the peripheral portion of the liquid crystal display panel 2. The SOF 22i is prepared such that the source drivers that drive the liquid crystal display panel 2, the control signal line arranged to distribute the control signals to the source drivers, the first kind terminal section, the second kind terminal sections, and the electric wire between the terminal sections are mounted on one film. Accordingly, the SOF 22i has the both functions of the source side common circuit board and the TABs on which the source drivers are mounted according to any one of the above-described preferred embodiments of the present invention. In addition, the SOF 22i includes an electric connection mechanism 51i for connection with the control circuit board (not shown) and electric connection mechanisms 52i for connection with the light source driving circuit board (not shown), and is brought into electric connections with the control circuit board and the light source driving circuit board via the electric connection mechanisms 51i and 52i. The configuration of the other constituent members is the same as any one of the above-described preferred embodiments of the present invention.

In the modified preferred embodiment shown in FIG. 16B, the SOFs 22j on which the source drivers are mounted overlap one another at their end portions, and the transmission and reception of the electric signals and the transmission of the electric power are performed between the SOFs 22j via the overlapping portions. The SOFs 22j are prepared such that the source drivers that drive the liquid crystal display panel 2, the control signal line arranged to distribute the control signal to the source drivers, and the electric wire between the first kind terminal section and the second kind terminal sections are provided. Accordingly, the SOFs 22j has the both functions of the source side common circuit board and the TABs on which the source drivers are mounted according to any one of the above-described preferred embodiments of the present invention. One of the SOFs 22j, which is attached to a center portion of one of the longer edges of the liquid crystal display panel 2, is brought into an electric connection with the control circuit board via the electric connection mechanism 51j. In addition, two of the SOFs 22j, which are attached to the both end portions of the longer edge of the liquid crystal display panel 2, are brought into electric connections with the light source driving circuit boards via the electric connection mechanisms 52j. The configuration of the other constituent members is the same as any one of the above-described preferred embodiments of the present invention.

Specific operations of the modified preferred embodiments of the present invention are the same as any one of the above-described preferred embodiments of the present invention, and detailed descriptions thereof are omitted.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-11. (canceled)

12. A display device comprising:
a display panel;
a display panel circuit board attached to the display panel along a peripheral portion of the display panel;
a light source; and
a light source driving circuit board arranged to drive the light source; wherein
a direct electric connection exists between the display panel circuit board and the light source driving circuit board.

13. The display device according to claim 12, wherein the display panel is an active matrix type display panel, and the display panel circuit board is a source side driving circuit board and/or a gate side driving circuit board.

14. The display device according to claim 12, wherein the direct electric connection between the display panel circuit board and the light source driving circuit board is established using a flexible electric cable and/or a film on which an electric wire is provided.

15. The display device according to claim 12, wherein the light source driving circuit board is arranged to receive a synchronizing signal of an image to be displayed on the display panel via the direct electric connection with the display panel circuit board.

16. The display device according to claim 12, wherein the light source driving circuit board is arranged to receive a gradient signal of an image to be displayed on the display panel via the direct electric connection with the display panel circuit board.

17. The display device according to claim 12, wherein the light source driving circuit board is arranged to receive electric power supplied from a power supply circuit via the direct electric connection with the display panel circuit board.

18. The display device according to claim 12, wherein the display device comprises a plurality of light source driving circuit boards, and the light source driving circuit boards are arranged to perform at least one of transmission and reception of electric signals via the direct electric connections with the display panel circuit board.

19. The display device according to claim 18, wherein the light source driving circuit boards are arranged to perform transmission and/or reception of synchronizing signals to and from each other so as to synchronously drive the light source.

20. The display device according to claim 18, wherein the light source driving circuit boards apply voltages in opposite phases to both ends of the light source based on the synchronizing signals.

21. The display device according to claim 18, wherein the light source driving circuit boards receive the synchronizing signal of the image to be displayed on the display panel via the direct electric connections with the display panel circuit board.

22. A television receiver comprising the display device according to claim 12.
